(19) United States
(12) Patent Application Publication
(10) Pub. No.: US 2011/0069133 A1
(43) Pub. Date: Mar. 24, 2011

(54) IMAGE FORMING APPARATUS

(75) Inventors: Takeshi SOWA, Matsumoto (JP); Ken IKUMA, Suwa (JP)

(73) Assignee: SEIKO EPSON CORPORATION, Tokyo (JP)

(21) Appl. No.: 12/871,214

(22) Filed: Aug. 30, 2010

(30) Foreign Application Priority Data
Sep. 18, 2009 (JP) 2009-216522

(51) Int. Cl. B41J 2/435

(52) U.S. Cl. 347/224

(57) ABSTRACT

An image forming apparatus includes: an exposure head that includes a light emitting device for emitting light having a first wavelength and a second wavelength and an optical system having a first lens surface through which the light emitted from the light emitting device enters and a second lens surface from which the light entered through the first lens surface is emitted, forms an image of the light having the first wavelength at a first image forming position, and forms an image of the light having the second wavelength at a second image forming position different from the first image forming position in an optical axis direction of the optical system; a latent image carrier onto which the light emitted from the second lens surface of the exposure head is irradiated and a latent image is formed; and a support member that supports the exposure head.

The support member supports the exposure head so that the exposure head and the latent image carrier have the following relationship:

d1<di<d2

here, d1, di, and d2 are defined as follows:

d1: a distance between the second lens surface and the first image forming position in the optical axis direction,

d2: a distance between the second lens surface and the second image forming position in the optical axis direction, and

di: a distance between the second lens surface and the image carrier in the optical axis direction.

### BACKGROUND

1. Technical Field

The present invention relates to an image forming apparatus that exposes an image carrier by using an exposure head that forms an image of light from a light emitting device by an optical system.

2. Related Art

In an image forming apparatus described in JP-A-2008-221790, an exposure head (line head in JP-A-2008-221790) including a light emitting device and an image forming optical system is arranged to face an image carrier, and when the image forming optical system forms an image of light from the light emitting device, a spot is formed on (a surface of) the image carrier. The exposure head appropriately forms spots at positions corresponding to image data, so that a predetermined latent image can be formed on the surface of the image carrier.

In an image forming apparatus as described above, a distance between the image forming position of the light of the optical system and the image carrier is important. Because, if the distance is too large, the spot formed on the image carrier by the optical system blurs and a good latent image may not be formed. Therefore, a technique for positioning the exposure head and the image carrier so that the image forming position of the light of the optical system is located near (the surface of) the image carrier has been required.

### SUMMARY

An advantage of some aspects of the invention is that it provides a technique capable of positioning the exposure head and the image carrier so that the image forming position of the light of the optical system is located near the image carrier and forming a good latent image by the exposure head.

To achieve the above object, the image forming apparatus according to an aspect of the invention includes: an exposure head that includes a light emitting device for emitting light having a first wavelength and a second wavelength and an optical system having a first lens surface through which the light emitted from the light emitting device enters and a second lens surface from which the light entered through the first lens surface is emitted, forms an image of the light having the first wavelength at a first image forming position, and forms an image of the light having the second wavelength at a second image forming position different from the first image forming position in an optical axis direction of the optical system; a latent image carrier onto which the light emitted from the second lens surface of the exposure head is irradiated and a latent image is formed; and a support member that supports the exposure head, wherein the support member supports the exposure head so that the exposure head and the latent image carrier have the following relationship:

d1<di<d2,

here, d1, di, and d2 are defined as follows:

d1: a distance between the second lens surface and the first image forming position in the optical axis direction,

d2: a distance between the second lens surface and the second image forming position in the optical axis direction, and

di: a distance between the second lens surface and the image carrier in the optical axis direction.

In the image forming apparatus constituted as described above, the optical system having the first lens surface and the second lens surface, and the light emitting device are provided, and the light that is emitted from the light emitting device and enters through the first lens surface is emitted from the second lens surface and irradiated onto the image carrier. The light emitting device according to an aspect of the invention emits the light having the first wavelength and the second wavelength, and the optical system forms images of the light of each wavelength at different positions (the first image forming position and the second image forming position) in the optical axis direction. The support member supports the exposure head having the optical system and the image carrier so that the relationship, d1<di<d2 is satisfied. Here, d1, di, and d2 are defined as follows:

d1: a distance between the second lens surface and the first image forming position in the optical axis direction,

d2: a distance between the second lens surface and the second image forming position in the optical axis direction, and

di: a distance between the second lens surface and the image carrier in the optical axis direction.

Specifically, in the image forming apparatus, the exposure head is positioned with respect to the image carrier so that (the surface of) the image carrier is located between the first image forming position and the second image forming position. By positioning the exposure head with respect to the image carrier in the manner described above, at least one of the two image forming positions (the first and the second image forming positions) can be located near (the surface of) the image carrier. Light formed into an image at the image forming position near the image carrier is used to form a spot on the image carrier, so that a good latent image with less blur can be formed.

The exposure head may include a second light emitting device that emits light and a second optical system that forms an image of the light emitted from the second light emitting device. In this case, the exposure head may be configured so that the image forming position at which the image of the light is formed by the second optical system may be located between the first image forming position and the second image forming position in the optical axis direction. In other words, according to an aspect of the invention, the exposure head is positioned with respect to the image carrier so that at least one of the two image forming positions (the first and the second image forming positions) of the optical system is located near (the surface of) the image carrier. Therefore, when the image forming position at which the image of the light is formed by the second optical system is located between the first image forming position and the second image forming position in the optical axis direction, the image forming position at which the image of the light is formed by the second optical system can be located near (the surface of) the image carrier, and as a result, a good latent image can be formed by the exposure head.

The range between the first image forming position and the second image forming position is a range between the first and the second image forming positions including the first image forming position and the second image forming position.

The support member may be configured to include a holding member that holds the exposure head and a contact member that is provided to the holding member and is in contact with the image carrier. By connecting the contact member coming into contact with the image carrier and the exposure head via the holding member in the manner described above, positioning accuracy of the exposure head with respect to the image carrier can be improved.

### BRIEF DESCRIPTION OF THE DRAWINGS

The invention will be described with reference to the accompanying drawings, wherein like numbers reference like elements.

FIG. 1 is a diagram showing an example of an image forming apparatus to which the invention can be applied.

FIG. 2 is a block diagram showing an electrical configuration of the image forming apparatus of FIG. 1.

FIG. 3 is a partial perspective view showing an outline of a line head.

FIG. 4 is a partial plan view of a head substrate viewed from the thickness direction.

FIG. 5 is a partial cross-sectional view taken along V-V line of the line head.

FIG. 6 is a partial side view of the line head.

FIG. 7 is a longitudinal direction partial cross-sectional view showing a line head support mechanism.

FIG. 8 is a perspective view showing the line head support mechanism.

FIG. 9 is a diagram showing details of a support form of the line head.

FIG. 10 is an enlarged diagram of an area near image forming positions P1 and P2.

### DESCRIPTION OF EXEMPLARY EMBODIMENTS

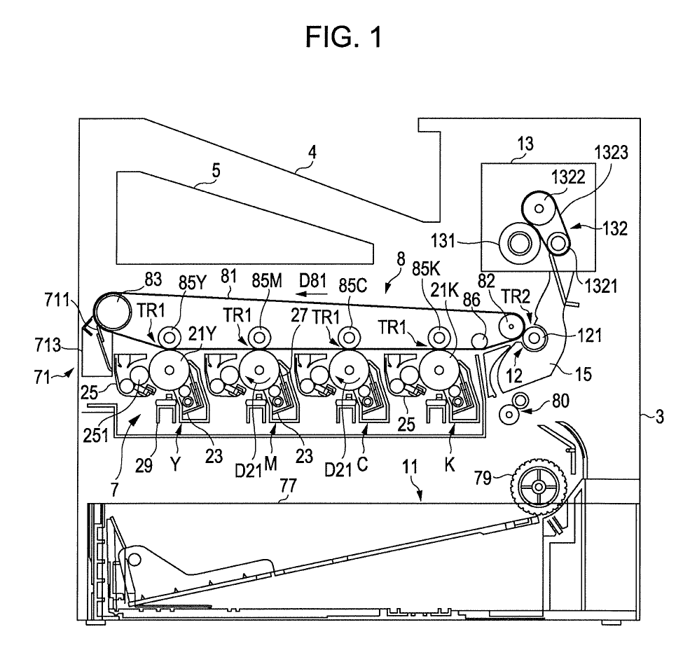

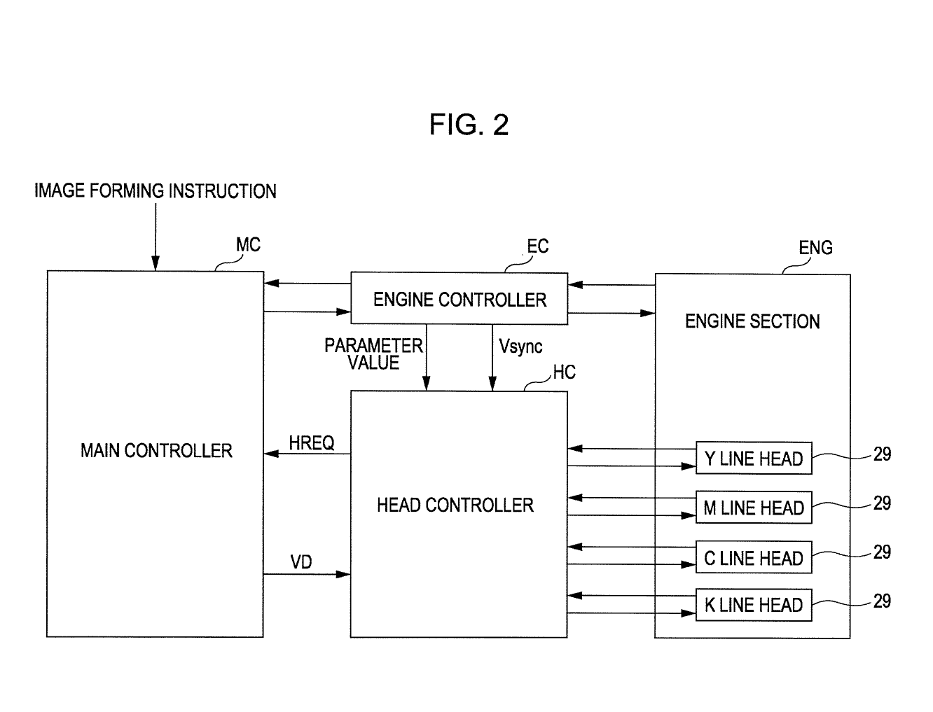

FIG. 1 is a diagram showing an example of an image forming apparatus to which the invention can be applied. FIG. 2 is a block diagram showing an electrical configuration of the image forming apparatus of FIG. 1. The image forming apparatus selectively performs a color mode in which a color image is formed by superimposing four color toners of black (K), cyan (C), magenta (M), and yellow (Y), and a monochrome color mode in which a monochrome image is formed by only black toner (K). FIG. 1 is a diagram when performing the color mode. In the image forming apparatus, when an image forming instruction is provided from an external apparatus such as a host computer to a main controller MC including a CPU, a memory, and the like, the main controller MC provides a control signal or the like to an engine controller EC and provides video data VD corresponding to the image forming instruction to a head controller HC. In this case, every time the main controller MC receives a horizontal request signal HREQ from the head controller HC, the main controller MC provides the video data VD for one line in the main scanning direction MD to the head controller HC. The head controller HC controls line heads 29 of each color on the basis of the video data VD from the main controller MC and a vertical synchronous signal Vsync and a parameter value from the engine controller EC. Based on this, an engine section ENG performs a predetermined image forming operation and forms an image corresponding to the image forming instruction on a sheet such as copying paper, transfer paper, plain paper, and OHP transparent sheet.

A housing main body 3 of the image forming apparatus includes an electrical component box 5 in which a power supply circuit board, the main controller MC, the engine controller EC, and the head controller HC are mounted. An image forming unit 7, a transfer belt unit 8, and a paper feed unit 11 are also arranged in the housing main body 3. In FIG. 1, a secondary transfer unit 12, a fixing unit 13, a sheet guide member 15 are arranged at the right side in the housing main body 3. The paper feed unit 11 is configured to be attachable/detachable to/from an apparatus main body 1. The paper feed unit 11 and the transfer belt unit 8 are configured so that they can be detached and repaired or replaced respectively.

An image forming unit 7 includes four image forming stations C (for cyan), M (for magenta), Y (for yellow), and K (for black) that form images of a plurality of different colors. Each image forming station Y, M, C, and K includes a photoconductor drum 21 having a cylindrical shape and a surface with a predetermined length in the main scanning direction MD. Each image forming station Y, M, C, and K forms a toner image of corresponding color on the surface of the photoconductor drum 21. The photoconductor drum 21 is arranged so that the axis direction is in parallel or approximately in parallel with the main scanning direction MD. Each photoconductor drum 21 is connected to a dedicated driving motor thereof, and driven to rotate at a predetermined speed in a direction of an arrow D21 in FIG. 1. Accordingly, the surface of the photoconductor drum 21 is transported in a sub-scanning direction SD perpendicular to or approximately perpendicular to the main scanning direction MD. A charging section 23, the line head 29, a developing section 25, and a photoconductor cleaner 27 are arranged around the photoconductor drum 21 along the rotation direction. A charging operation, a latent image forming operation, and a toner developing operation are performed by these functional sections. Accordingly, a color image is formed by superimposing toner images formed by all the image forming stations Y, M, C, and K on a transfer belt 81 of the transfer belt unit 8 when performing the color mode, and a monochrome image is formed using only a toner image formed by the image forming station K when performing the monochrome mode. Since the respective image forming stations in the image forming unit 7 have the same configuration, reference characters are given to only some of the image forming stations while being not given to the other image forming stations in order to facilitate the diagrammatic representation in FIG. 1.

The charging section 23 includes a charging roller, the surface of which is made of an elastic rubber. This charging roller is configured to be rotated by being held in contact with the surface of the photoconductor drum 21 at a charging position. As the photoconductor drum 21 rotates, the charging roller is rotated at the same circumferential speed in a direction driven by the photoconductor drum 21. This charging roller is connected to a charging bias generator (not shown in FIG. 1) and charges the surface of the photoconductor drum 21 at the charging position where the charging section 23 and the photoconductor drum 21 are in contact with each other upon receiving a supply of a charging bias from the charging bias generator.

The line head 29 is arranged separately from the photoconductor drum 21. The longitudinal direction of the line head 29 is in parallel with or approximately in parallel with the main scanning direction MD and the width direction of the line head 29 is in parallel with or approximately in parallel with the sub-scanning direction SD. The line head 29 includes a plurality of light emitting devices, and each light emitting device emits light in accordance with the video data VD from the head controller HC. The surface of the charged photoconductor drum 21 is irradiated by light beams emitted from the light emitting devices, and thereby a latent image is formed on the surface of the photoconductor drum 21.

The developing section 25 includes a developing roller 251 whose surface carries toner. Charged toner moves from the developing roller 251 to the photoconductor drum 21 at a developing position where the developing roller 251 and the photoconductor drum 21 are in contact with each other by a developing bias applied to the developing roller 251 from a developing bias generator (not shown FIG. 1) electrically connected to the developing roller 251, and the latent image formed by the line head 29 is visualized.

The toner image visualized at the developing position is transported in the rotation direction D21 of the photoconductor drum 21, and thereafter primary-transferred to the transfer belt 81 at primary transfer positions TR1 where the transfer belt 81 and each photoconductor drum 21 are in contact with each other.

In this embodiment, a photoconductor cleaner 27 is provided in contact with the surface of the photoconductor drum 21 on the downstream side of the primary transfer position TR1 and on the upstream side of the charging section 23 in the rotation direction D21 of the photoconductor drum 21. The photoconductor cleaner 27 cleans and eliminates the toner remaining on the surface of the photoconductor drum 21 after the primary transfer by coming in contact with the surface of the photoconductor drum.

The transfer belt unit 8 includes a driving roller 82, a driven roller 83 (blade-facing roller) arranged to the left of the driving roller 82 in FIG. 1, and the transfer belt 81 mounted on these rollers and driven to circulate in a direction of an arrow D81 (transportation direction) shown in FIG. 1. The transfer belt unit 8 includes, on an inner side of the transfer belt 81, four primary transfer rollers 85Y, 85M, 85C, and 85K that are arranged to face the respective photoconductor drums 21 included in the image forming stations Y, M, C, and K on one-on-one basis when a photoconductor cartridge is mounted. These primary transfer rollers 85 are electrically connected to a primary transfer bias generator (not shown in FIG. 1). When performing the color mode, as shown in FIG. 1, by positioning all the primary transfer rollers 85Y, 85M, 85C, and 85K on the image forming stations Y, M, C, and K, the transfer belt 81 is pressed to be in contact with each photoconductor drum 21 included in the image forming stations Y, M, C, and K, and the primary transfer positions TR1 are formed between each photoconductor drum 21 and the transfer belt 81. By applying a primary transfer bias from the primary transfer bias generator to the primary transfer rollers 85 at an appropriate timing, toner images formed on each photoconductor drum 21 are transferred to the surface of the transfer belt 81 at the primary transfer positions TR1 on each photoconductor drum 21, and a color image is formed.

On the other hand, when performing the monochrome mode, the color primary transfer rollers 85Y, 85M, and 85C among the four primary transfer rollers 85 are separated from the image forming stations Y, M, and C respectively facing the color primary rollers, and only the monochrome primary transfer roller 85K is brought into contact with the image forming station K, so that only the monochrome image forming station K is brought into contact with the transfer belt 81. As a result, the primary transfer position TR1 is formed only between the monochrome primary transfer roller 85K and the image forming station K. By applying a primary transfer bias from the primary transfer bias generator to the monochrome primary transfer roller 85K at an appropriate timing, a toner image formed on the photoconductor drum 21 is transferred to the surface of the transfer belt 81 at the primary transfer position TR1, and a monochrome image is formed.

Further, the transfer belt unit 8 includes a downstream guide roller 86 arranged on the downstream side of the monochrome primary transfer roller 85K and on the upstream side of the driving roller 82. The downstream guide roller 86 is configured to be in contact with the transfer belt 81 on an internal common tangent of the primary transfer roller 85K and the photoconductor drum 21 at the primary transfer position TR1 formed by the monochrome primary transfer roller 85K coming in contact with the photoconductor drum 21 of the image forming station K.

The driving roller 82 drives and circulates the transfer belt 81 in the direction of the arrow D81 shown in FIG. 1, and also serves as a backup roller of a secondary transfer roller 121. A rubber layer having the thickness of about 3 mm and volume resistivity equal to or lower than 1000 kΩ·cm is formed on a circumferential surface of the driving roller 82. The driving roller 82 is grounded via a metal shaft to thereby form a conductive path for a secondary transfer bias supplied from a secondary transfer bias generator not shown in FIG. 1 via the secondary transfer roller 121. The rubber layer having high friction and impact absorption is provided to the driving roller 82 in this way. Consequently, impact caused when a sheet enters a contact portion between the driving roller 82 and the secondary transfer roller 121 (a secondary transfer position TR2) is less easily transmitted to the transfer belt 81, and thus, it is possible to prevent deterioration in an image quality.

The paper feed unit 11 includes a paper feed cassette 77 capable of holding stacked sheets and a paper feed section having a pickup roller 79 that feeds the sheets one by one from the paper feed cassette 77. A paper feed timing of the sheet fed from the paper feed section by the pickup roller 79 is adjusted at a pair of registration rollers 80, and then fed to the secondary transfer position TR2 along the sheet guide member 15.

The secondary transfer roller 121 is provided to freely separate from and come into contact with the transfer belt 81 and is driven to separate from and come into contact with the transfer belt 81 by a secondary transfer roller driving mechanism (not shown in FIG. 1). The fixing unit 13 includes a heating roller 131 that incorporates a heating member such as a halogen heater and freely rotates and a pressing section 132 that presses and urges the heating roller 131. The sheet on the surface of which an image is secondarily transferred is guided by the sheet guide member 15 to a nip portion formed by the heating roller 131 and a pressing belt 1323 of the pressing unit 132. The image is thermally fixed at predetermined temperature in the nip portion. The pressing unit 132 includes two rollers 1321 and 1322 and the pressing belt 1323 mounted on these rollers. A belt stretched surface stretched by the two rollers 1321 and 1322 of the surface of the pressing belt 1323 is pressed against a circumferential surface of the heating roller 131, so that the nip portion formed by the heating roller 131 and the pressing belt 1323 is largely secured. The sheet on which fixing processing is performed in this way is transported to a paper discharge tray 4 provided in an upper surface section of the housing main body 3.

In this apparatus, a cleaner section 71 is disposed to face the blade-facing roller 83. The cleaner section 71 includes a cleaner blade 711 and a waste toner box 713. The cleaner blade 711 brings a distal end thereof into contact with the blade-facing roller 83 via the transfer belt 81 to remove foreign matters such as a toner and paper powder remaining on the transfer belt after the secondary transfer. The foreign matters removed in this way are collected in a waster toner box 713.

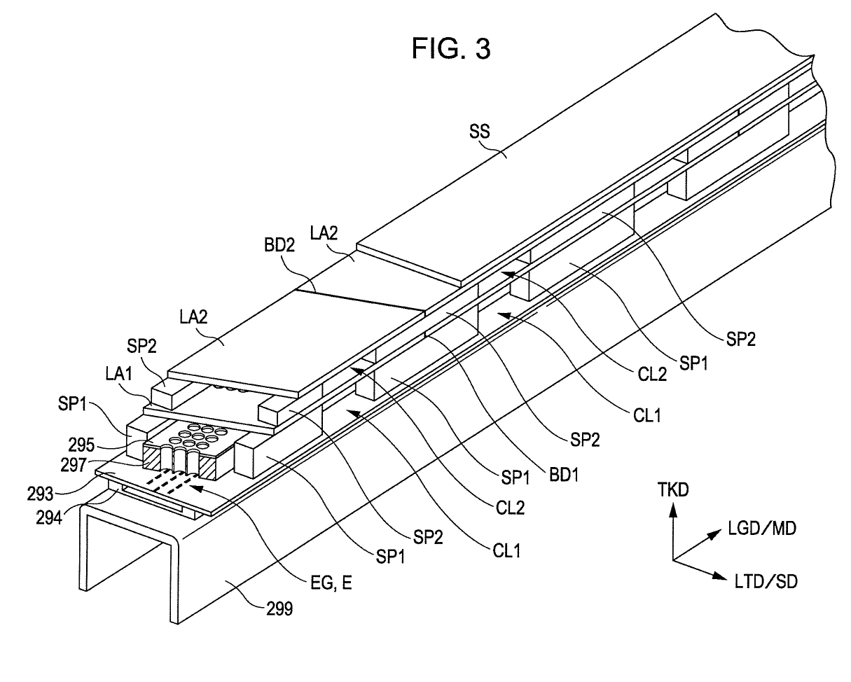

FIG. 3 is a partial perspective view showing an outline of the line head. In FIG. 3, to easily understand the configuration of the line head 29 in the thickness direction TKD, a cross-section of an edge portion (lower left edge portion in FIG. 3) in the longitudinal direction LGD of the line head 29 is shown. Here, the thickness direction is a direction perpendicular or approximately perpendicular to the longitudinal direction LGD and the width direction LTD, and the thickness direction is a direction in which light is emitted by the light emitting device E described below (in other word, a direction from the line head 29 to the photoconductor drum 21). In the description below of the embodiment, the downstream side of the thickness direction TKD (upper side of FIG. 3) is referred to as “one side (of the thickness direction)” and the upstream side of the thickness direction TKD (lower side of FIG. 3) is referred to as “the other side (of the thickness direction)”. One surface of a substrate or a flat plate is referred to as a front surface and the other surface of the substrate or the flat plate is referred to as a back surface.

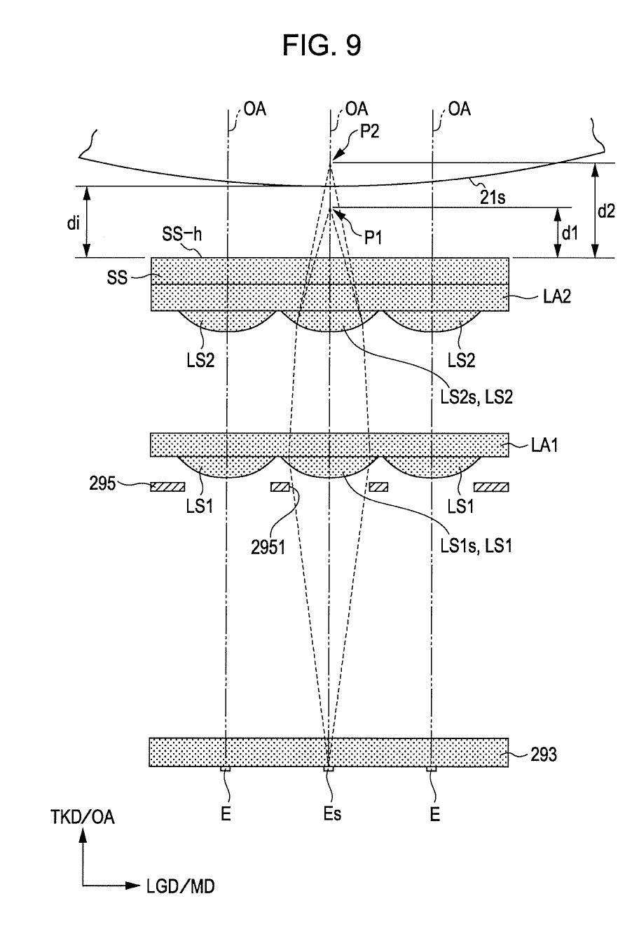

The thickness direction TKD is in parallel with an optical axis (optical axis OA in FIG. 9) of an image forming optical system constituted by a lens LS1 of a lens array LA1 and a lens LS2 of a lens array LA2. While a plurality of image forming optical systems of LS1 and LS2 are arranged in the line head 29 according to the embodiment, the optical axes OA of each image forming optical system are in parallel with each other. As described below, between the light emitting device E and the surface of the photoconductor drum 21, the lens LS1, a glass substrate SB, the lens LS2, the glass substrate SB, and a support glass SS are arranged in this order, and these components cooperate to function as one image forming optical system. In this embodiment, this image forming optical system is abbreviated as an image forming optical system LS1, LS2 (or LS1s, LS2s).

Here, the optical axis is defined as described below. Many image forming optical systems are plane symmetry (mirror symmetry) with respect to a symmetry plane perpendicular to the main scanning direction MD and plane symmetry (mirror symmetry) with respect to a symmetry plane perpendicular to the sub-scanning direction SD. In this way, the image forming optical system has a first symmetry plane perpendicular to the main scanning direction MD and a second symmetry plane perpendicular to the sub-scanning direction SD perpendicular to the main scanning direction MD, and a line of intersection of the first symmetry plane and the second symmetry plane is defined. When the image forming optical system is rotation symmetry, the line of intersection of the first symmetry plane and the second symmetry plane corresponds to the optical axis. When the image forming optical system is not rotation symmetry, the optical axis of the image forming optical system may not be technically defined. In such a case, the line of intersection described above may be used as the optical axis.

The line head 29 has a schematic configuration in which a head substrate 293, a light shielding member 297, a diaphragm plate 295, the lens array LA1, and the lens array LA2 are arranged in the thickness direction TKD in this order. On the back surface of the head substrate 293, a plurality of light emitting devices E are divided into groups as light emitting device groups EG, each of which includes a predetermined number of light emitting devices E, and arranged two-dimensionally and discretely. To the back surface of the head substrate 293, a sealing member 294 to seal the plurality of light emitting devices E is attached. Furthermore, to the back surface of the sealing member 294, a rigid member 299 to support the above components constituting the line head 29 is attached.

A spacer SP1 is provided between the head substrate 293 and the lens array LA1, and the spacer SP1 defines the distance between the head substrate 293 and the lens array LA1. The light shielding member 297 and the diaphragm plate 295 mounted on the light shielding member 297 are arranged between the head substrate 293 and the lens array LA1, and the spacer SP1 supports the lens array LA1 while maintaining a certain distance between the diaphragm plate 295 and the lens array LA1 in one side of the thickness direction TKD. A spacer SP2 is provided between the lens array LA1 and the lens array LA2, and the spacer SP2 defines the distance between the lens array LA1 and the lens array LA2 and supports the lens array LA2.

In this way, in the line head 29, the head substrate 293, the light shielding member 297, the diaphragm plate 295, and the lens arrays LA1 and LA2 are arranged in this order. Light from the light emitting device E on the head substrate 293 passes through a light guide hole 2971 in the light shielding member 297 and an aperture stop 2951 of the diaphragm plate 295, and the light is formed into an image by the lenses LS1 and LS2 of the lens arrays LA1 and LA2. Next, detailed configuration of each component will be described with reference to FIGS. 3, 4, and 5.

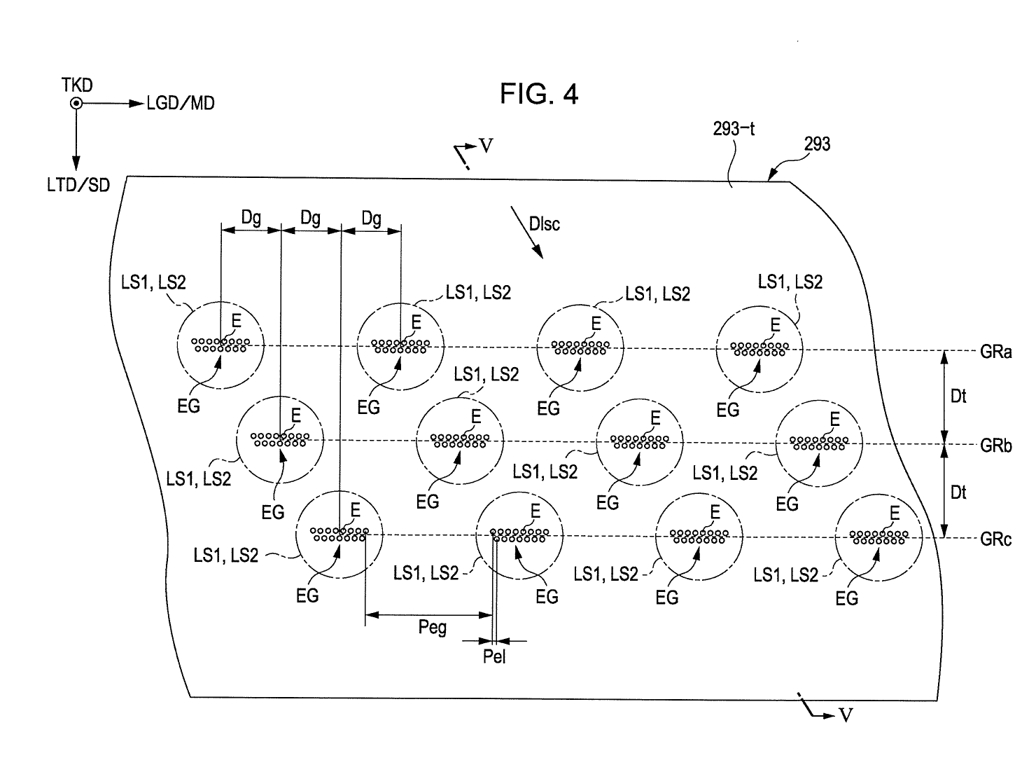

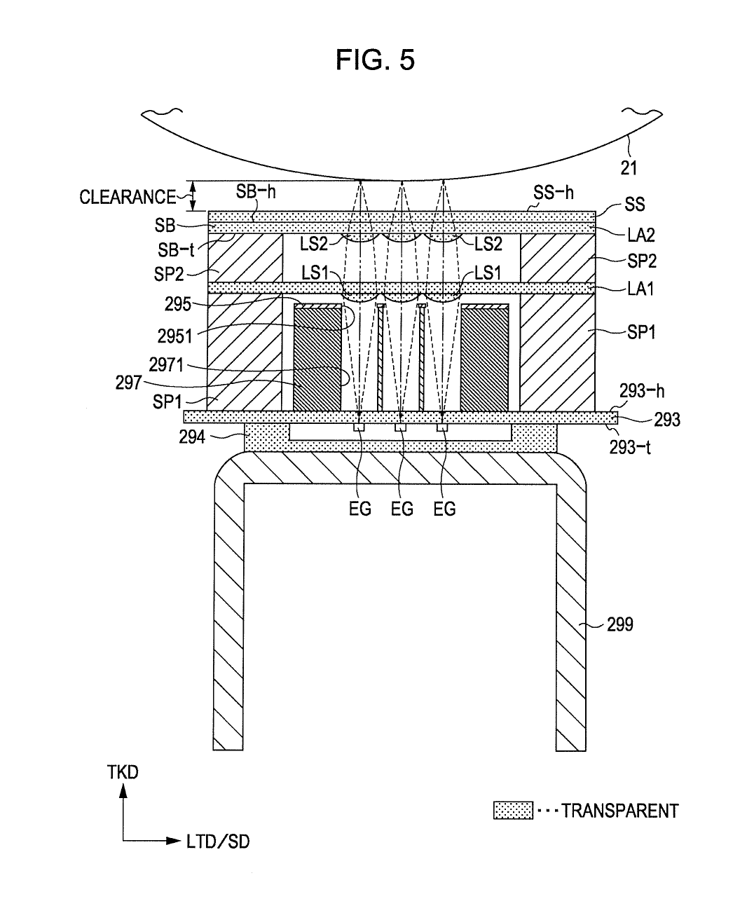

FIG. 4 is a partial plan view of the head substrate 293 viewed from the thickness direction TKD. FIG. 4 corresponds to a perspective view of the back surface 293-t of the head substrate 293 viewed from one side in the thickness direction TKD (viewed from the upper side of FIG. 3) FIG. 5 is a partial cross-sectional view taken along V-V line of the line head, and corresponds to a view of the cross-section viewed from the longitudinal direction LGD (the main scanning direction MD). This V-V line cross-section passes through geometric centers of gravity (or centers of lenses) of three light emitting device groups EG (or three lenses LS1 or the like) aligning in a line at an interval of Dg in the longitudinal direction LGD and at an interval of Dt in the width direction LTD. The direction Dlsc shown in FIGS. 4 and 5 is in parallel with the V-V line. Further, in FIG. 4, to show positional relationship among the light emitting device group EG formed on the head substrate 293, the lens LS1 formed in the lens array LA1, and the lens LS2 formed in the lens array LA2, the lens LS1 and the lens LS2 are indicated by a dashed-dotted line. The description regarding the lens LS1 and the lens LS2 in FIG. 4 is to show the positional relationship among them, but not to show that the lens LS1 and the lens LS2 are formed on the back surface 293-t of the head substrate (FIG. 5). In FIG. 5, shading using dots is given to light transmissive components (or transparent components).

The head substrate 293 is constituted by a glass substrate (light transmissive substrate) through which light passes. On the back surface 293-t of the head substrate, a plurality of light emitting devices E, which are bottom emission type organic EL (Electro-Luminescence) devices, are formed and sealed by the sealing member 294 (FIGS. 3 and 4). The plurality of light emitting devices E have the same emission spectrum and emit light beams to the surface of the photoconductor drum 21. As shown in FIG. 4, an arrangement pattern of the plurality of light emitting devices E formed on the back surface 293-t of the head substrate has a group structure. Specifically, 15 light emitting devices E are arranged in a two-row zigzag pattern in the longitudinal direction LGD to form one light emitting device group EG, and further a plurality of light emitting device groups EG are discretely arranged in a three-row zigzag pattern in the longitudinal direction LGD.

The arrangement pattern will be described below in more detail. Specifically, in each light emitting device group EG, 15 light emitting devices E are arranged at positions different from each other in the longitudinal direction LGD, and further, the distance between two light emitting devices E and E adjacent to each other in the longitudinal direction LGD is a device-to-device distance Pel (in other words, in each light emitting device group EG, 15 light emitting devices E are arranged in the longitudinal direction LGD at a pitch Pel). The plurality of light emitting device groups EG are discretely arranged along the longitudinal direction LGD with a group-to-group distance Peg larger than the device-to-device distance Pel in between, and one light emitting device group row GRa or the like is formed. Further, three light emitting device group rows GRa, GRb, and GRc are discretely arranged at positions different from each other with a distance Dt in between in the width direction LTD, and the light emitting device group rows GRa, GRb, and GRc are shifted from each other by a distance Dg in the longitudinal direction LGD. In this way, three light emitting device groups EG are aligned in a direction Dlsc with the distance Dg in between in the longitudinal direction LGD and with the distance Dt in between in the width direction LTD.

Here, the device-to-device distance Pel can be obtained as a distance between geometric centers of gravity of two target light emitting devices E in the longitudinal direction LGD. The group-to-group distance Peg can be obtained as a distance between two target light emitting device groups EG in the longitudinal direction LGD, specifically as a distance between a geometric center of gravity of a light emitting device E at an end of one light emitting device group EG near the other light emitting device group EG in the longitudinal direction LGD and a geometric center of gravity of a light emitting device E at an end of the other light emitting device group EG near the one light emitting device group EG in the longitudinal direction LGD. The distance Dg can be obtained as a distance in the longitudinal direction LGD between geometric centers of gravity of two light emitting device groups EG located adjacent to each other in the longitudinal direction LGD. The distance Dt can be obtained as a distance in the width direction LTD between geometric centers of gravity of two light emitting device groups EG located adjacent to each other in the width direction LTD.

As described above, on a back surface 293-t of the head substrate 293, a plurality of light emitting device groups EG are arranged two-dimensionally and discretely. On the other hand, on a front surface 293-h of the head substrate 293, the light shielding member 297 is disposed. In the light shielding member 297, a plurality of light guide holes 2971 penetrating in the thickness direction TKD are formed. Each light guide hole 2971 has a circular shape in a plan view seen from the thickness direction TKD, and black plating is performed on an internal wall thereof. The light guide hole 2971 is formed for each light emitting device group EG, in other words, one light guide hole 2971 is opened for one light emitting device group EG. In this way, the light shielding member 297 is in contact with the front surface 293-h of the head substrate 293 and fixed to the front surface 293-h of the head substrate 293 while the light guide holes 2971 are opened for the light emitting device groups EG.

The purpose of providing the light shielding member 297 is to prevent so-called stray light from entering the lens LS1 or LS2. Specifically, the image forming optical system constituted by a pair of lenses LS1 and LS2 is dedicatedly provided to each light emitting device group EG. In such a configuration, a light beam is desired to enter only the image forming optical system of LS1 and LS2 provided to the light emitting device group EG from which the light beam is emitted and be formed into an image. However, a part of the light beam is not directed to the image forming optical system of LS1 and LS2 provided to the light emitting device group EG from which the light beam is emitted and becomes the stray light. When such stray light enters an image forming optical system of LS1 and LS2 that is not provided to the light emitting device group EG from which the light beam is emitted, a so-called ghost may appear. Considering the above, in this embodiment, the light shielding member 297 is provided between the light emitting device group EG and the image forming optical system of LS1 and LS2. Since the light guide holes 2971 in which black plating is performed on the inner wall thereof are provided and opened to the light emitting device groups EG, a large part of the stray light is absorbed by the inner walls of the light guide holes 2971. As a result, the ghost mentioned above is suppressed and a good exposure operation is realized.

Further, the diaphragm plate 295 is mounted on one end of the light shielding member 297 in the thickness direction TKD. In the diaphragm plate 295, the aperture stop 2951 penetrating in the thickness direction TKD is formed for each light emitting device group EG, in other words, one aperture stop 2951 is opened for one light emitting device group EG. The aperture stop 2951 is provided for the image forming optical system constituted by the lens LS1 and the lens LS2 to perform a desired image forming operation. Specifically, the aperture stop 2951 controls an amount of the light beam entering the lens LS1 and adjusts an amount of light that is used to form a spot and affects the size and the shape of the spot formed finally.

As described above, on one side of the head substrate 293, the light shielding member 297, and the diaphragm plate 295 in the thickness direction TKD, the lens arrays LA1 and LA2 are provided, and the lens arrays LA1 and LA2 are supported by the spacers SP1 and SP2. Details of the support structure of the lens arrays LA1 and LA2 will be described with reference to FIGS. 3, 5, and 6.

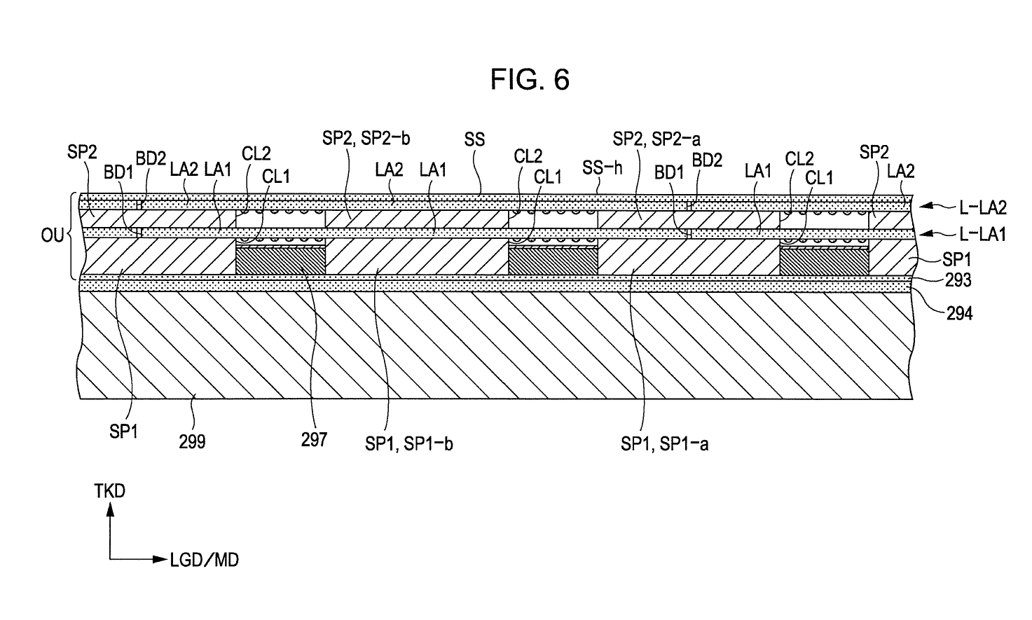

FIG. 6 is a partial cross-sectional view of the line head, and corresponds to a plan view of the line head 29 viewed from the width direction LTD. On the front surface of the head substrate 293, a plurality of spacers SP1 having the same shape and size are arranged in a row with an interval CL1 in the longitudinal direction LGD. The row of the spacers SP1 is provided at both sides in the width direction LTD (FIGS. 3 and 5). In this way, in a plan view viewed from the thickness direction TKD, two rows of spacers SP1 are arranged sandwiching the area where the light emitting devices E are formed on the back surface 293-t of the head substrate from the width direction LTD (in other word, two rows of spacers SP1 are arranged sandwiching the light shielding members 297 from the width direction LTD). The spacers SP1 are fixed to the front surface 293-h of the head substrate 293 by adhesive or the like.

The lens array LA1 is mounted in the width direction LTD on the spacers SP1 arranged in two rows in this way, so that the lens array LA1 is positioned on one side of the thickness direction TKD of the head substrate 293. At this time, the lens array LA1 is disposed so that an area where the lenses LS1 are formed in the lens array LA1 is located between the two rows of spacers SP1 arranged in the width direction LTD. The lens array LA1 includes a rhomboid-shaped glass substrate SB whose both edges in the longitudinal direction LGD are cut obliquely (in a direction in parallel with the direction Dlsc). On the back surface of the glass substrate SB, a plurality of lenses LS1 formed of a light curing resin are arranged in arrays. The plurality of lenses LS1 are arranged in a three-row zigzag pattern corresponding to the arrangement of the opposing light emitting device groups EG (FIG. 4).

As shown in FIGS. 3 and 6, a plurality of lens arrays LA1 are arranged along the longitudinal direction LGD. Specifically, in this embodiment, the plurality of lens arrays LA1 arranged along the longitudinal direction LGD are supported by the spacers SP1, and a long lens array L-LA1 is formed. The length of the spacer SP1 having a rectangular solid shape is smaller than the longitudinal direction LGD length of the width direction LTD side of the lens array LA1, and one lens array LA1 is supported by the plurality of spacers SP1 arranged along the longitudinal direction LGD. Specifically, regarding the spacers SP1, a center spacer SP1-b supports the approximate center of the lens array LA1 in the longitudinal direction LGD, and an end spacer SP1-a bridges a gap BD1 between two lens arrays LA1 and LA1 adjacent to each other in the longitudinal direction LGD and supports the lens arrays LA1 and LA1. The spacers SP1 and the lens array LA1 are fixed to each other by adhesive or the like.

On one surface in the depth direction TKD of the long lens array L-LA1 formed in this way, a plurality of spacers SP2 having the same shape and size are arranged in a row with an interval CL2 in the longitudinal direction LGD. The row of the spacers SP2 is provided at both sides in the width direction LTD (FIGS. 3 and 5). In this way, in a plan view viewed from the thickness direction TKD, two rows of spacers SP2 are arranged sandwiching the area where the lenses LS1 of the lens array LA1 are formed from the width direction LTD. The spacers SP2 are fixed to the front surface of the glass substrate SB of the lens array LA1 by adhesive or the like.

The lens array LA2 is mounted in the width direction LTD on the spacers SP2 arranged in two rows in this way, so that the lens array LA2 is positioned on one side of the thickness direction TKD of the lens array LA1. At this time, the lens array LA2 is disposed so that an area where the lenses LS2 are formed in the lens array LA2 is located between the two rows of spacers SP2 arranged in the width direction LTD. The lens array LA2 includes a rhomboid-shaped glass substrate SB whose both edges in the longitudinal direction LGD are cut obliquely (in a direction in parallel with the direction Dlsc). On the back surface of the glass substrate SB, a plurality of lenses LS2 formed of a light curing resin are arranged in arrays. The plurality of lenses LS2 are arranged in a three-row zigzag pattern corresponding to the arrangement of the opposing light emitting device groups EG (FIG. 4).

As shown in FIGS. 3 and 6, a plurality of lens arrays LA2 are arranged along the longitudinal direction LGD. Specifically, in this embodiment, the plurality of lens arrays LA2 arranged along the longitudinal direction LGD are supported by the spacers SP2, and a long lens array L-LA2 is formed. The length of the spacer SP2 having a rectangular solid shape is smaller than the longitudinal direction LGD length of the width direction LTD side of the lens array LA2, and one lens array LA2 is supported by the plurality of spacers SP2 arranged along the longitudinal direction LGD. Specifically, regarding the spacers SP2, a center spacer SP2-b supports the approximate center of the lens array LA2 in the longitudinal direction LGD, and an end spacer SP2-a bridges a gap BD2 between two lens arrays LA2 and LA2 adjacent to each other in the longitudinal direction LGD and supports the lens arrays LA2 and LA2. The spacers SP2 and the lens array LA2 are fixed to each other by adhesive or the like.

In this way, the lens array LA1 and the lens array LA2 are arranged so that they face each other in the thickness direction TKD. As a result, a plurality of lenses LS1 of the lens array LA1 and a plurality of lenses LS2 of the lens array LA2 face each other in a one-to-one relation, and positions of the lens array LA1 and the lens array LA2 are adjusted so that the lenses LS1 and the lenses LS2 facing each other overlap each other in a plan view viewed from the thickness direction TKD.

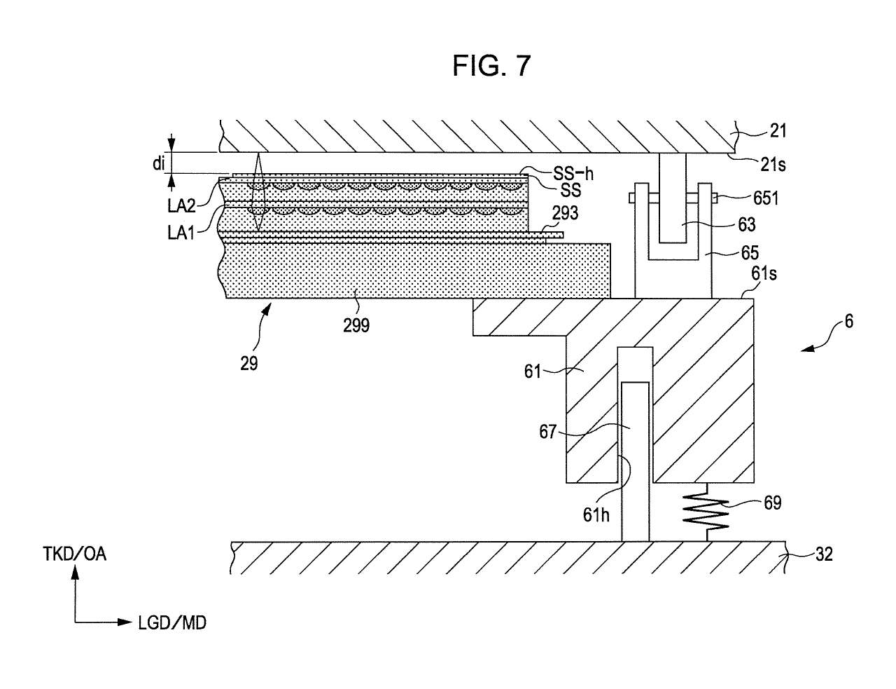

Further, in this embodiment, a long support glass SS is provided in the longitudinal direction LGD direction. Specifically, in the longitudinal direction LGD, the support glass SS is formed longer than the lens array LA2, and has approximately the same length as that of the long lens array L-LA2. The support glass SS is attached to one surface of the long lens array L-LA2, so that the support glass SS supports the plurality of lens arrays LA2 from the opposite side of the spacers SP2. A front surface SS-h (one flat surface) of the support glass SS faces a surface 21s (drum circumferential surface) of the photoconductor drum 21 with a clearance (distance di) between them (FIG. 7).

In this embodiment, the lens LS1 and the lens LS2 facing each other in the thickness direction TKD constitute one image forming optical system. This image forming optical system forms an upside-down reduced-size image, and the magnification thereof is negative and has an absolute value smaller than 1. Therefore, after the light beam emitted from the light emitting device E passes through the lenses LS1 and LS2, the light beam is emitted from the front surface SS-h of the support glass SS and irradiated onto the surface of the photoconductor drum 21 as a spot ST (FIG. 5). A line latent image extending in the main scanning direction MD can be formed by controlling light emitted from each light emitting device E in accordance with the movement of the surface of the photoconductor drum 21 in the sub-scanning direction SD as shown in FIG. 11 or the like in JP-A-2008-036937.

By the way, each spot ST used to form the line latent image needs to be formed in a size corresponding to resolution of the latent image. However, as described above, when the line head 29 (exposure head) and the photoconductor drum 21 (image carrier) are not appropriately positioned, the spots ST blur, and spots ST having a desired size may not be formed. Therefore, in the image forming apparatus according to this embodiment, a line head support mechanism 6 is provided to correctly position the line head 29 with respect to the photoconductor drum 21.

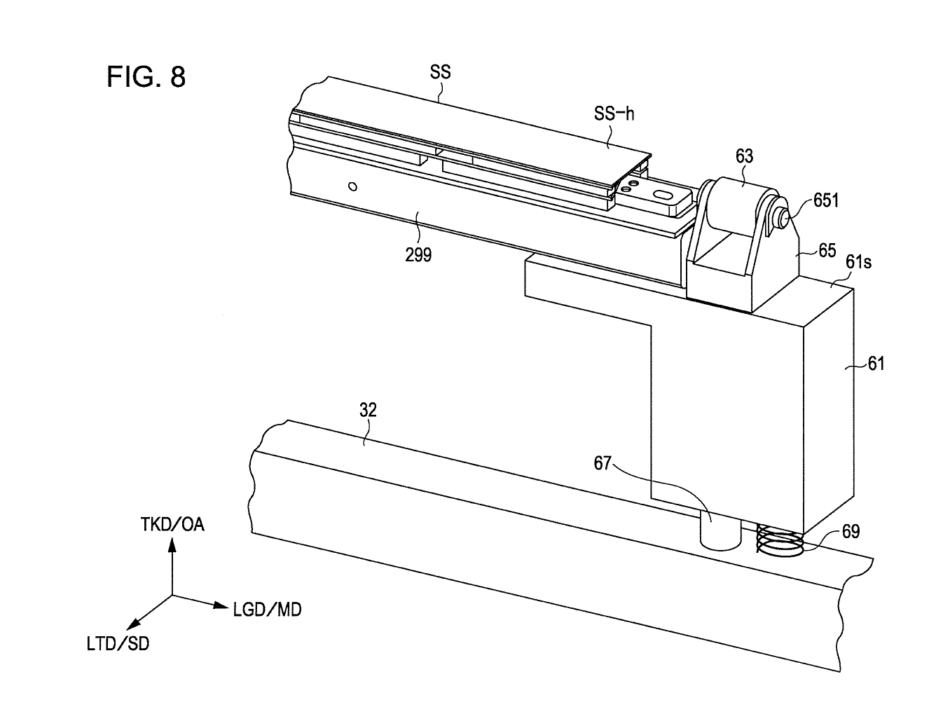

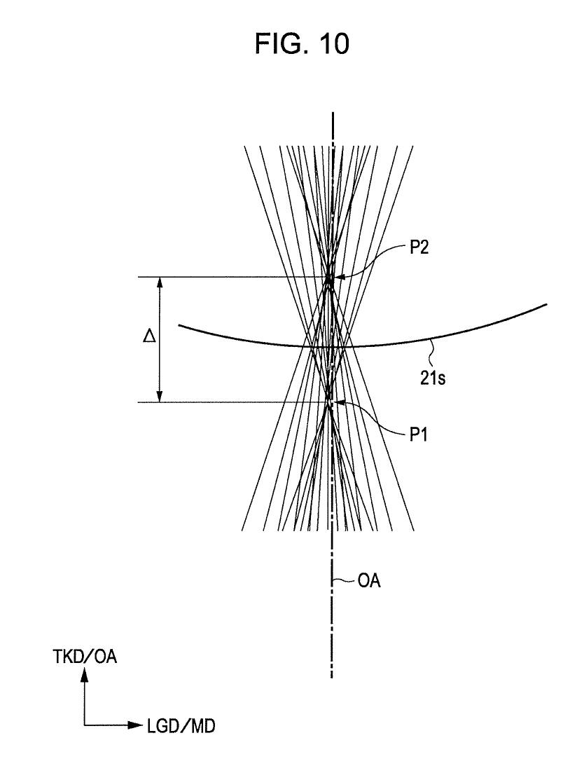

FIG. 7 is a longitudinal direction partial cross-sectional view showing the line head support mechanism. FIG. 8 is a perspective view showing the line head support mechanism. Although the line head support mechanism 6 is disposed at each of both ends of the line head 29 in the longitudinal direction LGD, the configurations of both line head support mechanisms 6 and 6 are the same. Therefore, the configuration of the line head support mechanism 6 disposed at one end in the longitudinal direction LGD will be described in detail below. As described above, the thickness direction TKD is in parallel with the optical axis of the image forming optical system constituted by the lenses LS1 and LS2. Therefore, in FIGS. 7 and 8 (and FIGS. 9 and 10 described below), the optical axis direction OA is indicated along with the thickness direction TKD.

As described in FIGS. 7 and 8, the line head support mechanism 6 includes a holding member 61 that holds the line head 29, a gap roller 63 that comes in contact with the surface 21s (drum circumferential surface 21s) of the photoconductor drum 21, a roller support member 65 that is fixed to the holding member 61 and supports the gap roller 63, a slider 67 that fits into the holding member 61, and a pressing spring 69 that urges the holding member 61 in the thickness direction TKD.

The holding member 61 supports the line head 29 from the direction opposite to the optical axis direction OA of the photoconductor drum 21. More specifically, one side of the holding member 61 in the optical axis direction OA is a holding surface 61s formed into a flat surface shape perpendicular to the optical axis direction OA, and the holding surface 61s is brought in contact with the rigid member 299 of the line head 29 and fixed. Further, the roller support member 65 is attached to the holding surface 61s of the holding member 61. The roller support member 65 includes a roller support shaft 651 in parallel with the rotation axis of the photoconductor drum 21, and the gap roller 63 is rotatably supported by the roller support shaft 651. The gap roller 63 has a disk shape with the roller support shaft 651 at its center. The gap roller 63 is rotated in accordance with the rotation of the photoconductor drum surface 21s while the circumferential surface of the gap roller 63 is in contact with the photoconductor drum surface 21s.

The pressing spring 69 is provided between the holding member 61 and a main body frame 32 of the housing main body 3 in the optical axis direction OA. One end of the pressing spring 69 is attached to the holding member 61 in the opposite side of the optical axis direction (opposite side of the holding surface 61s), and the other end of the pressing spring 69 is attached to the main body frame 32. Therefore, the holding member 61 is urged in the optical axis direction OA by the pressing spring 69, so that the holding member 61 freely moves in the optical axis direction OA. A cylindrical shaped fitting hole 61h is formed in the holding member 61 in the opposite side of the optical axis direction OA, and a cylindrical shaped slider 67 fits into the fitting hole 61h.

Although the holding member 61 receives an urging force from the pressing spring 69, the holding member 61 is controlled to move in the optical axis direction OA by the fitting hole 61h and the slider 67. Therefore, the holding member 61 is urged in the optical axis direction OA. On the other hand, the gap roller 63 is provided on one side of the holding member 61. Therefore, the holding member 61 is in a stable state at a position a predetermined distance from the photoconductor drum surface 21s while the gap roller 63 is pressed against the photoconductor drum surface 21s by the urging force from the pressing spring 69. By holding the line head 29 by the holding member 61, the line head 29 can be supported with a predetermined clearance from the photoconductor drum surface 21s. More specifically, in this embodiment, the line head 29 is supported so that the relationship described below is satisfied.

FIG. 9 is a diagram showing details of a support form of the line head, and corresponds to a plan view of the V-V line cross-section viewed from the width direction LTD. Like the light emitting device Es shown in FIG. 9, the line head 29 according to this embodiment includes a light emitting device emitting light having a wavelength λ1 and a wavelength λ2 different from the wavelength λ1. The image forming optical system of LS1s and LS2s faces the light emitting device Es, forms an image of the light having the wavelength λ1 at an image forming position P1, and forms an image of the light having the wavelength λ2 at an image forming position P2 a distance A apart from the image forming position P1 in the optical axis direction OA. FIG. 10 is an enlarged diagram of an area near the image forming positions P1 and P2. As shown in FIG. 10, the light from the light emitting device Es is formed into an image at the image forming position P1 and the image forming position P2 a distance A apart from the image forming position P1 in the optical axis direction OA.

In this embodiment, the line head 29 is supported so that the distance d1, the distance d2, and the distance di satisfy the following relation equation A:

d1<di<d2 . . . Relation equation A

Here, d1, di, and d2 are defined as follows:
d1: a distance between an optical surface (front surface SS-h of the support glass) nearest to the photoconductor drum surface 21s in the optical surfaces of the image forming optical system of LS1s and LS2s and the image forming position P1 in the optical axis direction OA,
d2: a distance between the optical surface (front surface SS-h of the support glass) nearest to the photoconductor drum surface 21s in the optical surfaces of the image forming optical system of LS1s and LS2s and the image forming position P2 in the optical axis direction OA,
di: a distance between the optical surface (front surface SS-h of the support glass) nearest to the photoconductor drum surface 21s in the optical surfaces of the image forming optical system of LS1s and LS2s and the photoconductor drum surface 21s in the optical axis direction OA.

In this embodiment, the light emitting device Es and the image forming optical system of LS1 and LS2 as described above are arranged in approximately the center of the latent image forming area (approximately the center of the main scanning direction MD) of the line head 29. In this case, image forming positions where other image forming optical systems of LS1 and LS2 form images of the light from the light emitting devices E are not largely apart from the photoconductor drum surface 21s, so that a good latent image can be formed by the spots ST with less blurs.

As described above, in this embodiment, the image forming optical system in which a lens surface of a first lens LS1 (a first lens surface) is used as an entrance surface and the front surface SS-h of the support glass is used as an emission surface, and the light emitting device Es are provided. The light emitting device Es emits the light having the wavelength λ1 (first wavelength) and the wavelength λ2 (second wavelength), and the image forming optical system of LS1s and LS2s forms images of the light of the wavelengths λ1 and λ2 at different positions (the image forming position P1 and the image forming position P2) in the optical axis direction OA. The line head support mechanism 6 (support member) supports the line head 29 including such an optical system and the photoconductor drum 21 so that the above relation equation A is satisfied. Specifically, in this image forming apparatus, the line head 29 is positioned with respect to the photoconductor drum 21 so that the surface 21s of the photoconductor drum 21 is positioned between the image forming position P1 (first image forming position) and the image forming position P2 (the second image forming position). By positioning the line head 29 with respect to the photoconductor drum 21 in this way, the surface 21s of the photoconductor drum 21 can be positioned in a range between the two image forming positions P1 and P2 of the image forming optical system of LS1s and LS2s (in other words, in a range indicated by the reference character Δ in FIG. 10), and the other image forming optical systems of LS1 and LS2 can form an image of the light from the light emitting device E at a position near the photoconductor drum 21. Thus, the line head 29 can form a good latent image by the spots ST with less blur. The range between the mage forming position P1 and the image forming position P2 is a range between the two image forming positions P1 and P2 including the image forming position P1 and the image forming position P2.

The line head 29 includes the light emitting devices E in addition to the light emitting device Es, and the image forming optical systems of LS1 and LS2 that form images of the light from the light emitting devices E in addition to the image forming optical system of LS1s and LS2s. The image forming positions of the light by the image forming optical systems of LS1 and LS2 other than the image forming optical system of LS1s and LS2s are desired to be in a range between the image forming position P1 and the image forming position P2 in the optical axis direction OA, and in such a case, the image forming optical systems of LS1 and LS2 other than the image forming optical system of LS1s and LS2s can form spots ST with further less blur. Specifically, the line head 29 is positioned with respect to the photoconductor drum 21 so that at least one of the two image forming positions P1 and P2 of the image forming optical system of LS1s and LS2s is positioned near the surface of the photoconductor drum 21. Therefore, when the image forming positions of the light by the image forming optical systems of LS1 and LS2 other than the image forming optical system of LS1s and LS2s are in the range between the image forming position P1 and the image forming position P2 in the optical axis direction OA, the image forming positions of the light by the image forming optical systems of LS1 and LS2 other than the image forming optical system of LS1s and LS2s can be positioned within a distance Δ from the surface 21s of the photoconductor drum 21, and as a result, a good latent image can be formed by the line head 29.

In the above embodiment, the line head support mechanism 6 includes the holding member 61 that holds the line head on the opposite side of the optical axis direction OA of the photoconductor drum 21, and the gap roller 63 (contact member) that is disposed to the holding member 61 and brought into contact with the photoconductor drum 21. By connecting the gap roller 63 coming into contact with the photoconductor drum 21 and the line head 29 via the holding member 61 in the manner described above, positioning accuracy of the line head 29 with respect to the photoconductor drum 21 can be improved.

Others

As described above, in the above embodiment, the line head 29 corresponds to the “exposure head” of the invention, the photoconductor drum 21 corresponds to the “image carrier” of the invention, and the line head support mechanism corresponds to the “support member” of the invention. The light emitting device Es corresponds to the “light emitting device” of the invention, the light having the wavelength λ1 corresponds to the “light having the first wavelength” of the invention, the light having the wavelength λ2 corresponds to the “light having the second wavelength” of the invention, the image forming optical system of LS1s and LS2s corresponds to the “optical system” of the invention, the image forming position P1 corresponds to the “first image forming position” of the invention, and the image forming position P2 corresponds to the “second image forming position” of the invention. The light emitting device E other than the light emitting device Es corresponds to the “second light emitting device” of the invention, and the image forming optical system other than the image forming optical system of LS1s and LS2s corresponds to the “second optical system” of the invention. The gap roller 63 corresponds to the “contact member” of the invention. The lens surface of the lens LS1 corresponds to the “first lens surface” of the invention, and the front surface SS-h of the support glass corresponds to the “second lens surface” of the invention.

The invention is not limited to the above embodiment, but various modifications can be made without departing from the spirit and scope of the invention. For example, the light emitting devices E other than the light emitting device Es that emits light having the wavelengths λ1 and λ2 may emit light having two wavelength components. Further, the light having two wavelengths emitted from such a light emitting device E may be formed into images at different image forming positions in the optical axis direction OA by the image forming optical system of LS1 and LS2 other than the image forming optical system of LS1s and LS2s.

In this case, although there are a plurality of image forming optical systems of LS1 and LS2 that form light into images at two different image forming positions in the optical axis direction OA, it is not necessary for all of the plurality of image forming optical systems of LS1 and LS2 to satisfy the above relation equation A. Specifically, at least one image forming optical system of LS1 and LS2 (LS1s and LS2s) needs to satisfy the above relation equation A.

Although the support glass SS is provided in the above embodiment, the line head 29 may be configured without providing the support glass SS. In this case, the front surface SB-h (FIG. 5) of the glass substrate SB of the lens array LA2 is the “optical surface nearest to the photoconductor drum surface 21s in the optical surfaces of the image forming optical system of LS1s and LS2s”.

Although the plurality of lens arrays LA1 have the same shape and size in the above embodiment, various modifications can be made to the shape and the size. Further, the same modifications can be made to the plurality of lens arrays LA2.

Although the plurality of spacers SP1 have the same shape and size in the above embodiment, various modifications can be made to the shape and the size. Further, the same modifications can be made to the plurality of spacers SP2.

Although the image forming optical system in the above embodiment forms an upside-down image, the image forming optical system may form a normal image (or not-upside-down image).

Although the image forming optical system in the above embodiment forms a reduced-size image, the image forming optical system may form an enlarged image.

Although the lenses LS1 are formed on the back surface (the other side of the thickness direction TKD) of the lens array LA1 in the above embodiment, the forming position of the lenses LS1 are not limited to this. This is the same for the lenses LS2 of the lens array LA2.

Although lenses are arranged in a three-row zigzag pattern in the lens arrays LA1 and LA2 in the above embodiment, the arrangement pattern of the lenses is not limited to this.

In the above embodiment, the lens arrays LA1 and LA2 are lens arrays in which the lenses LS1 or LS2 made of resin are formed on the light transmissive substrate SB made of glass. However, the lens arrays LA1 and LA2 can be integrally formed from one material.

Although the plurality of light emitting device groups EG are arranged in a three-row zigzag pattern in the above embodiment, the arrangement pattern of the plurality of light emitting device groups EG is not limited to this.

In the above embodiment, the light emitting device group EG is constituted by 15 light emitting devices E. However, the number of the light emitting devices E constituting the light emitting device group EG is not limited to this.

Although the plurality of light emitting devices E are arranged in a two-row zigzag pattern in the light emitting device group EG in the above embodiment, the arrangement pattern of the plurality of light emitting devices E in the light emitting device group EG is not limited to this.

In the above embodiment, bottom emission type organic EL devices are used as the light emitting devices E. However, top emission type organic EL devices may be used as the light emitting devices E, or LEDs (Light Emitting Diodes) or the like other than the organic EL devices may be used as the light emitting devices E.

The entire disclosure of Japanese Patent Applications No. 2009-216522, filed on Sep. 18, 2009 is expressly incorporated by reference herein.

What is claimed is:

1. An image forming apparatus comprising:
an exposure head that includes a light emitting device for emitting light having a first wavelength and a second wavelength and an optical system having a first lens surface through which the light emitted from the light emitting device enters and a second lens surface from which the light entered through the first lens surface is emitted, forms an image of the light having the first wavelength at a first image forming position, and forms an image of the light having the second wavelength at a second image forming position different from the first image forming position in an optical axis direction of the optical system;
a latent image carrier onto which the light emitted from the second lens surface of the exposure head is irradiated and a latent image is formed; and
a support member that supports the exposure head,
wherein the support member supports the exposure head so that the exposure head and the latent image carrier have the following relationship:
d1<di<d2
here, d1, di, and d2 are defined as follows:
d1: a distance between the second lens surface and the first image forming position in the optical axis direction,
d2: a distance between the second lens surface and the second image forming position in the optical axis direction, and
di: a distance between the second lens surface and the image carrier in the optical axis direction.

2. The image forming apparatus according to claim 1, wherein
the exposure head includes a second light emitting device that emits light and a second optical system that forms an image of the light emitted from the second light emitting device.

3. The image forming apparatus according to claim 2, wherein
an image forming position at which the image of the light is formed by the second optical system is located between the first image forming position and the second image forming position in the optical axis direction.

4. The image forming apparatus according to claim 1, wherein
the support member includes a holding member that holds the exposure head and a contact member that is provided to the holding member and is in contact with the latent image carrier.
